(19) United States
(12) Patent Application Publication
(10) Pub. No.: US 2026/0088299 A1
(43) Pub. Date: Mar. 26, 2026

(54) OXIDE PARTICLE COATED WITH AMINO GROUPS

(71) Applicant: ZHI FENG LUO, Shenzhen (CN)

(72) Inventor: ZHI FENG LUO, Shenzhen (CN)

(21) Appl. No.: 18/896,953

(22) Filed: Sep. 26, 2024

(51) Int. Cl. H01M 4/62; H01M 4/02; H01M 4/485; H01M 10/0525

(52) U.S. Cl. CPC H01M 4/628; H01M 4/485; H01M 2004/021; H01M 2004/028; H01M 10/0525

(57) ABSTRACT

An oxide particle coated with amino groups, which is a composite LLZO particle; the composite LLZO particle includes a first LLZO particle. A hydroxide ion layer is coated on an outer surface of the first LLZO particle. The hydroxide ion layer and the first LLZO particle form a second order LLZO composite particle. A dopamine layer is coated on an outer side of the second order LLZO composite particle. Dopamine molecules of the dopamine layer are hydrophobic to protect the first LLZO particle and to prevent the first LLZO particle from being dampened. A CTAB (cetyltrimethylammonium bromide) layer is coated on an outer side of the dopamine layer. A part of the CTAB molecules is mixed within the dopamine layer and the hydroxide ion layer.

### FIELD OF THE INVENTION

The present invention is related to a battery electrode material, and in particular to an oxide particle coated with amino groups.

### BACKGROUND OF THE INVENTION

A typical battery is formed by the electrodes (positive and negative) placed in an electrolyte. In the prior art, LLZO (lithium lanthanum zirconium oxide) material is added into the electrodes to increase the ionic conductivity. Because LLZO particles has a high ionic conductivity for lithium ions, when lithium ions pass through the electrode, the lithium ions can be dispersed by the guiding of the dispersed LLZO particles. Therefore, the lithium ions can be evenly distributed inside the electrode, which avoids the abnormal accumulation of lithium ions in the electrode slurry to cause a side reaction.

However, the LLZO material is easy to perform a side reaction with other materials in the electrode during the manufacturing of the electrode slurry, resulting in deterioration of the material in the electrode slurry.

### SUMMARY OF THE INVENTION

Accordingly, for improving above mentioned defects in the prior art, the object of the present invention is to provide an oxide particle coated with amino groups, wherein a first LLZO particle is coated with a hydroxide ion layer to form a second order LLZO composite particle, and the second order LLZO composite particle is coated with a dopamine layer and a CTAB layer to form a composite LLZO particle. The dopamine layer is hydrophobic and serves to prevent the external water from entering into the first LLZO particle. The composite LLZO particle is further coated with carbon nanotubes and nanoscale amorphous carbons to increase the lithium ion conductivity, wherein the nanoscale amorphous carbons are filled in the gaps of the carbon nanotubes to increase the electrical conductivity. The dopamine layer, CTAB layer, carbon nanotubes and nanoscale amorphous carbons form multiple protective structures for the first LLZO particle, which increases the lithium-conducting property of the first LLZO particle, avoids side reactions of the first LLZO particle and the material of the electrode slurry, and achieves a better quality in battery electrode material manufacturing.

To achieve above object, the present invention provides an oxide particle coated with amino groups, which is a composite LLZO particle; the composite LLZO particle being used in an electrode of a solid-state or semi-solid battery; and the electrode including a substrate and an electrode slurry layer coated on the substrate; the composite LLZO particle comprising: a first LLZO particle serving to guide and disperse paths of the lithium ions, and to cause that evenly distributed lithium ion channels are formed inside the electrode; a hydroxide ion layer coated on an outer surface of the first LLZO particle; the hydroxide ion layer and the first LLZO particle forming a second order LLZO composite particle; the hydroxide ion layer being formed by a reaction of tris (tris(hydroxymethyl)aminomethane, (HOCH₂)₃CNH₂) molecules and having a plurality of third OH⁻ ions; each of the tris molecules having three OH⁻ ions which are a first OH⁻ ion, a second OH⁻ ion and the third OH⁻ ion; the first OH⁻ ions and the second OH⁻ ions of the tris molecules being bound to oxidizing functional groups on the first LLZO particle by hydrogen bonding; and the third OH⁻ ions of the tris molecules extending outward to an outer side of the first LLZO particle to form the hydroxide ion layer; and a dopamine layer coated on an outer side of the second order LLZO composite particle; the dopamine layer being formed by a plurality of dopamine molecules copolymerized; a polymerization triggered by dehydration being performed between OH⁻ ions of the dopamine molecules and the third OH⁻ ions of the hydroxide ion layer of a corresponding second order LLZO composite particle to cause that the dopamine layer are connected to the second order LLZO composite particle through the hydroxide ion layer; and the dopamine molecules of the dopamine layer being hydrophobic to protect the first LLZO particle and to prevent the first LLZO particle from being dampened.

### BRIEF DESCRIPTION OF THE DRAWINGS

FIG. 1 is a schematic view showing the structure of the present invention.

FIG. 2 shows an application of the structure of the present invention.

FIG. 3 is a schematic view showing the full structure and a partial structure of the hydroxide ion layer of the present invention.

FIG. 4 is a schematic view showing the structure of the third order LLZO composite particle of the present invention.

FIG. 5 is a schematic view showing the full structure and the partial structure of the composite LLZO particle, wherein the polymerization triggered by dehydration is formed between the OH⁻ ion of the dopamine of the dopamine layer and the third OH⁻ ion of the hydroxide ion layer.

FIG. 6 is a schematic view showing a partial structure of the composite LLZO particle of the present invention, wherein the attractions are formed between the OH⁻ ion of the CTAB and dopamine and the third OH⁻ ion of the hydroxide ion layer.

FIG. 7 is a cross-section view showing the structure of the composite LLZO particle of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

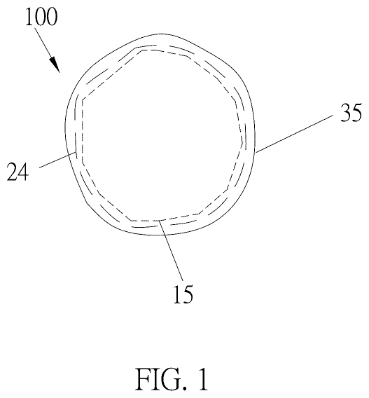

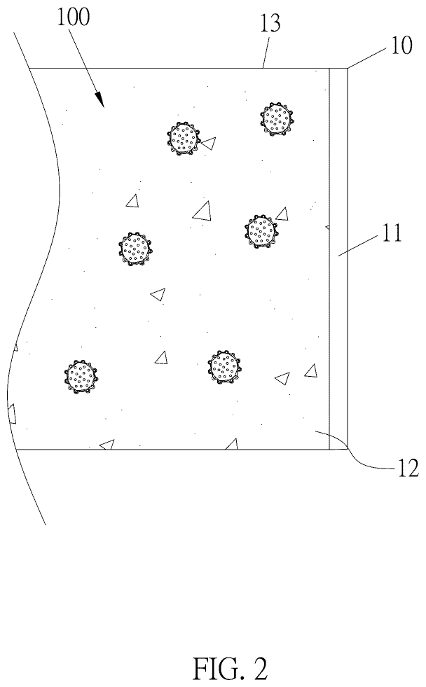

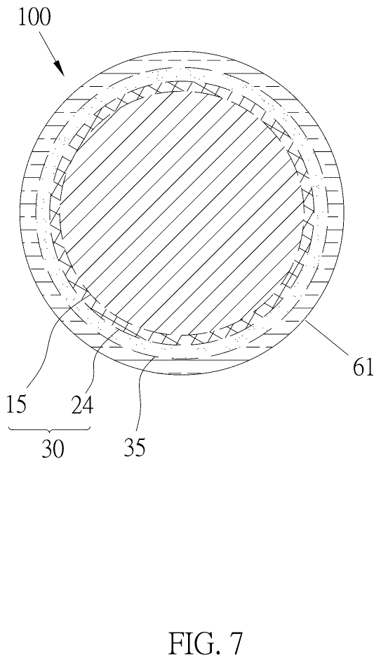

With reference to FIGS. 1 to 7, the present invention provides an oxide particle coated with amino groups. The oxide particle is a composite LLZO particle 100. The composite LLZO particle 100 is used in an electrode 10 of a solid-state or semi-solid battery. In the application, a plurality of composite LLZO particles 100 can be added into the electrode 10, wherein the electrode 10 is in particular a positive electrode of the solid-state or semi-solid battery. A size of the composite LLZO particle 100 is 50 nm to 200 nm. The electrode 10 includes a substrate 11 for carrying the material of the electrode 10, and an electrode slurry layer 13 coated on the substrate 11. The electrode slurry layer 13 includes the composite LLZO particles 100 and an electrode slurry 12 which is used as a binder. A weight percentage of the composite LLZO particles 100 in an electrode slurry layer 13 (in particular a positive electrode slurry layer) is 0.5wt%˜5wt%.

The composite LLZO particle 100 includes the following elements.

A first LLZO particle 15. Since LLZO material has a high ionic conductivity, when lithium ions pass through the electrode, the first LLZO particle 15 serves to guide and disperse paths of the lithium ions, and to cause that evenly distributed lithium ion channels are formed inside the electrode, which avoids the abnormal accumulation of lithium ions in the electrode slurry to cause a side reaction.

The first LLZO particle 15 is formed by LLZO (lithium lanthanum zirconium oxide, Li₇La₃Zr₂O₁₂) or LLZO doped with at least one metal (such as gallium (Ga)-doped LLZO (Li_{6.2}Ga_{0.8}La₃Zr₂O₁₂), aluminum (Al)-doped LLZO or barium (Ba)-doped LLZO.

Since moisture exists during the manufacturing process of the electrode, and the LLZO particles are hydrophilic and is easy to be dampened to form an alkali. Therefore, in the present invention, an outer side of the first LLZO particle 15 is coated with a protective layer (the following dopamine layer 35) to prevent the first LLZO particle 15 from being dampened during the manufacturing process of the electrode.

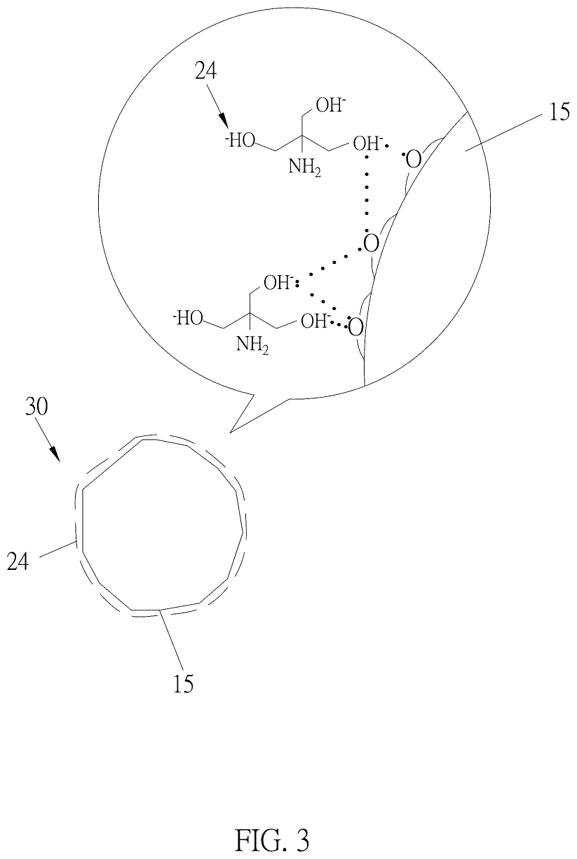

A hydroxide ion (OH⁻ ) layer 24 is coated on an outer surface of the first LLZO particle 15. The hydroxide ion layer 24 and the first LLZO particle 15 form a second order LLZO composite particle 30 (as shown in FIG. 3). A thickness of the hydroxide ion layer 24 is 0.5 nm˜2 nm. The hydroxide ion layer 24 is formed by a reaction of tris (tris(hydroxymethyl)aminomethane, (HOCH₂)₃CNH₂) molecules and has a plurality of third OH⁻ ions. The tris molecules are added in the manufacturing process of the composite LLZO particle 100. Each of the tris molecules has three OH⁻ ions which are a first OH⁻ ion, a second OH⁻ ion and the third OH⁻ ion. The first OH⁻ ions and the second OH⁻ ions of the tris molecules are bound to oxidizing functional groups on the first LLZO particle 15 by hydrogen bonding. The third OH⁻ ions of the tris molecules extend outward to an outer side of the first LLZO particle 15 to form the hydroxide ion layer 24. FIG. 3 shows an example of only two tris molecules and is not used to limit the scope of the present invention.

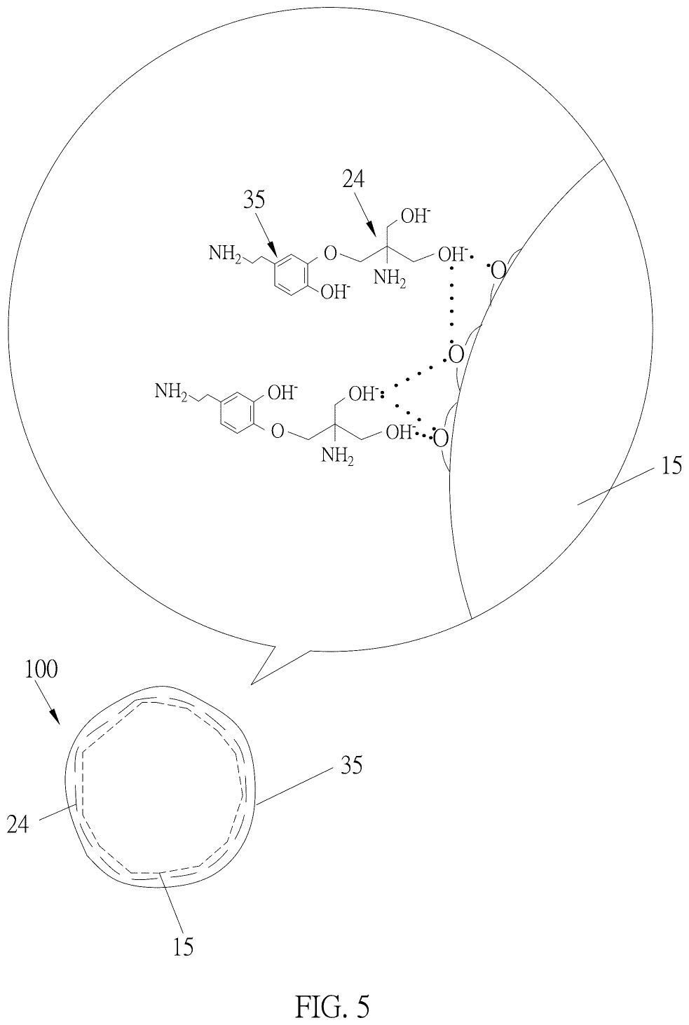

A dopamine layer 35 is coated on an outer side of the second order LLZO composite particle 30. The dopamine layer 35 is formed by a plurality of dopamine molecules copolymerized. A polymerization triggered by dehydration is performed between OH⁻ ions of the dopamine molecules and the third OH⁻ ions of the hydroxide ion layer 24 of a corresponding second order LLZO composite particle 30 to cause that the dopamine layer 35 is connected to the second order LLZO composite particle 30 through the hydroxide ion layer 24 (as shown in FIG. 5). A thickness of the dopamine layer 35 is 1 nm˜10 nm.

Since moisture exists during the manufacturing process of the electrode slurry, and the LLZO particles are hydrophilic and is easy to be dampened to form an alkali which destroys the lithium-conducting property of the LLZO particle. Therefore, the dopamine is used in the present invention. Because the dopamine molecules of the dopamine layer 35 are hydrophobic to protect the first LLZO particle 15 and to prevent the first LLZO particle 15 from being dampened.

The hydroxide ion layer 24 is used to connect the first LLZO particle 15 and the dopamine layer 35. Because the OH⁻ ion of the hydroxide ion layer 24 has a polarity, by coating the hydroxide ion layer 24 on the outer surface of the first LLZO particle 15, the dopamine layer 35 can be reacted with the hydroxide ion layer 24 and is more stably attached on the second order LLZO composite particle 30.

The composite LLZO particle 100 further includes a CTAB (cetyltrimethylammonium bromide) layer 61 coated on an outer side of the dopamine layer 35. The CTAB layer 61 is formed by a plurality of CTAB (cetyltrimethylammonium bromide) molecules 60. The CTAB molecules 60 are used as a surfactant. A part of the CTAB molecules 60 is mixed within the dopamine layer 35 and the hydroxide ion layer 24. A surplus of the CTAB molecules 60 surrounds the outer side of the dopamine layer 35.

A ratio of a total weight of the CTAB molecules 60 of the CTAB layer 61 and a total weight of the dopamine molecules of the dopamine layer 35 is 0.1%˜0.3%.

The structure of the CTAB molecules 60 on the outer side of the dopamine layer 35 and the CTAB molecules 60 within the dopamine layer 35 and the hydroxide ion layer 24 is a naturally produced result in the manufacturing process. In the CTAB layer 61, a part of the CTAB molecules 60 having a specific polarity attracts the molecules having an opposite polarity in the dopamine layer 35 and the hydroxide ion layer 24 to cause that the part of the CTAB molecules 60 will be mixed within the dopamine layer 35 and the hydroxide ion layer 24. A surplus of the CTAB molecules 60 of the CTAB layer 61 will surround on the outer side of the dopamine layer 35 by attractions formed between the polarities of the surplus CTAB molecules.

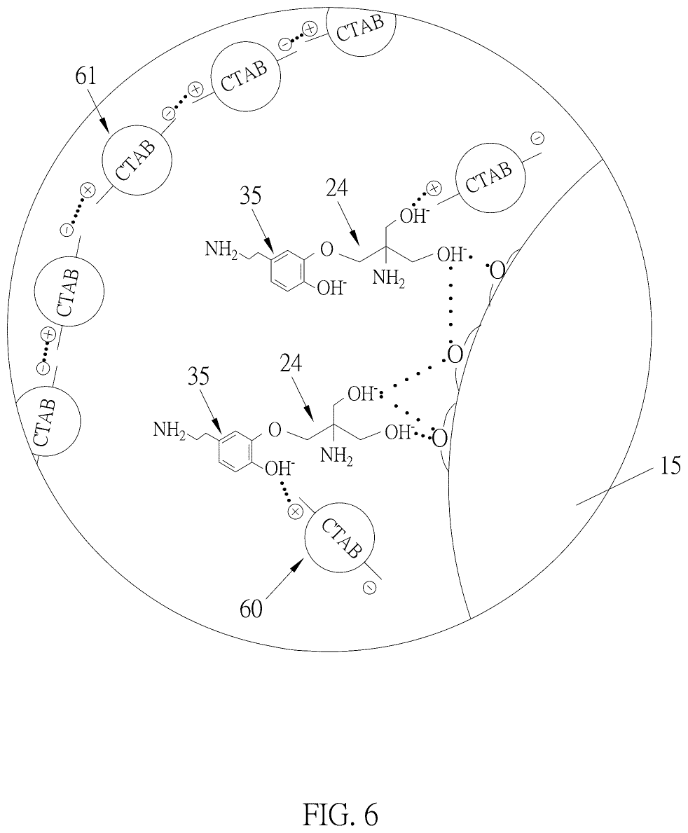

The CTAB layer 61 serves to make the first LLZO particle 15 have a higher disperstiveness without an agglomeration, and to reduce a chance of fluorination induced by interaction with Li between the first LLZO particle 15 and PVDF (polyvinylidene difluoride) in a positive electrode slurry. For a plurality of first LLZO particles 15, concentrated electric charges are required if the agglomeration is to be avoided. In the modification of the first LLZO particle 15, an outer surface of the first LLZO particle 15 maybe has exposed OH⁻ ions (including the third OH⁻ ion of the hydroxide ion layer 24 and the OH⁻ ion of dopamine molecules of the dopamine layer 35). By using the CTAB molecule 60, two ends of the CTAB molecule 60 have a positive electric charge and negative electric charge respectively (as shown in FIG. 6), the end of the CTAB molecule 60 with the positive electric charge can attract the exposed OH⁻ ion and the overall electrical property. Therefore, the surface coating completeness of the composite LLZO particle 100 can be increased and the dopamine molecules will not be agglomerated. The ions also will not be exposed on the outer surface of the composite LLZO particle 100, which prevents alkalization.

Because not all of the third OH⁻ ions of the hydroxide ion layer 24 and all of the OH⁻ ions of the dopamine molecules of the dopamine layer 35 perform the polymerization triggered by dehydration, the exposed OH⁻ ions will be formed. The CTAB molecule 60 can create attraction with the exposed OH⁻ ions and form a layer-by-layer protective structure, which makes the overall coating more complete.

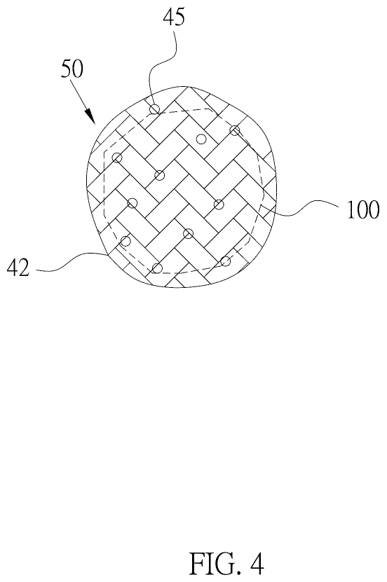

A plurality of carbon nanotubes 42 and a plurality of nanoscale amorphous carbons 45 are coated on an outer side of the composite LLZO particle 100. The carbon nanotubes 42, the nanoscale amorphous carbons 45 and the composite LLZO particle 100 form a third order LLZO composite particle 50 (as shown in FIG. 4). A size of each of the carbon nanotubes 42 is 200 nm˜500 nm. A size of each of the nanoscale amorphous carbons 45 is 10 nm˜40 nm. Preferably, the nanoscale amorphous carbons 45 are amorphous carbons of a Super P auxiliary agent.

A ratio of a total weight of the carbon nanotubes 42 and the nanoscale amorphous carbons 45 and a weight of the first LLZO particle 15 is 0.2˜2:99.8˜98.

The carbon nanotubes 42 and the nanoscale amorphous carbons 45 are used as an auxiliary agent. Because the nanoscale amorphous carbons 45 are in a form of particles, and the carbon nanotubes 42 are in a form of long strips, a plurality of gaps are formed in the interleaving structure formed by the carbon nanotubes 42 and are unable to conduct the electric current. Therefore, the nanoscale amorphous carbons 45 are filled in the gaps to transmit the electric charge between the carbon nanotubes 42 through the spanning of the nanoscale amorphous carbons 35, which further increases the transmitting efficiency of the electric current.

The advantages of the carbon nanotubes 42 are that the lithium ions are easy to be stabilized between the carbon nanotubes 42, therefore the lithium ion conductivity can be increased. The very high lithium ion conductivity helps the whole battery to charge and discharge quickly. In addition, the use of cobalt also can be reduced, so that the overall production cost can be reduced.

The advantages of the present invention are that a first LLZO particle is coated with a hydroxide ion layer to form a second order LLZO composite particle, and the second order LLZO composite particle is coated with a dopamine layer and a CTAB layer to form a composite LLZO particle. The dopamine layer is hydrophobic and serves to prevent the external water from entering into the first LLZO particle. The composite LLZO particle is further coated with carbon nanotubes and nanoscale amorphous carbons to increase the lithium ion conductivity, wherein the nanoscale amorphous carbons are filled in the gaps of the carbon nanotubes to increase the electrical conductivity. The dopamine layer, CTAB layer, carbon nanotubes and nanoscale amorphous carbons form multiple protective structures for the first LLZO particle, which increases the lithium-conducting property of the first LLZO particle, avoids side reactions of the first LLZO particle and the material of the electrode slurry, and achieves a better quality in batter electrode material manufacturing.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An oxide particle coated with amino groups, which is a composite LLZO particle; the composite LLZO particle being used in an electrode of a solid-state or semi-solid battery; and the electrode including a substrate and an electrode slurry layer coated on the substrate; the composite LLZO particle comprising:
a first LLZO particle serving to guide and disperse paths of the lithium ions, and to cause that evenly distributed lithium ion channels are formed inside the electrode;
a hydroxide ion layer coated on an outer surface of the first LLZO particle; the hydroxide ion layer and the first LLZO particle forming a second order LLZO composite particle; the hydroxide ion layer being formed by a reaction of tris (tris(hydroxymethyl)aminomethane, (HOCH₂)₃CNH₂) molecules and having a plurality of third OH⁻ ions; each of the tris molecules having three OH⁻ ions which are a first OH⁻ ion, a second OH⁻ ion and the third OH⁻ ion; the first OH⁻ ions and the second OH⁻ ions of the tris molecules being bound to oxidizing functional groups on the first LLZO particle by hydrogen bonding; and the third OH⁻ ions of the tris molecules extending outward to an outer side of the first LLZO particle to form the hydroxide ion layer; and
a dopamine layer coated on an outer side of the second order LLZO composite particle; the dopamine layer being formed by a plurality of dopamine molecules copolymerized; a polymerization triggered by dehydration being performed between OH⁻ ions of the dopamine molecules and the third OH⁻ ions of the hydroxide ion layer of a corresponding second order LLZO composite particle to cause that the dopamine layer are connected to the second order LLZO composite particle through the hydroxide ion layer; and the dopamine molecules of the dopamine layer being hydrophobic to protect the first LLZO particle and to prevent the first LLZO particle from being dampened.

2. The oxide particle coated with the amino groups as claimed in claim 1, wherein the composite LLZO particle further comprises a CTAB (cetyltrimethylammonium bromide) layer coated on an outer side of the dopamine layer; and the CTAB layer being formed by a plurality of CTAB (cetyltrimethylammonium bromide) molecules which are used as a surfactant.

3. The oxide particle coated with the amino groups as claimed in claim 2, wherein in the CTAB layer, a part of the CTAB molecules having a specific polarity attracts molecules having an opposite polarity in the dopamine layer and the hydroxide ion layer to cause that the part of the CTAB molecules is mixed within the dopamine layer and the hydroxide ion layer; and
wherein a surplus of the CTAB molecules of the CTAB layer surround on the outer side of the dopamine layer by attractions formed between the polarities of the surplus CTAB molecules.

4. The oxide particle coated with the amino groups as claimed in claim 3, wherein a ratio of a total weight of the CTAB molecules of the CTAB layer and a total weight of the dopamine molecules of the dopamine layer is 0.1%˜0.3%; and
wherein the CTAB layer serves to make the first LLZO particle have a higher disperstiveness without an agglomeration, and to reduce a chance of fluorination induced by interaction with Li between the first LLZO particle and a positive electrode slurry.

5. The oxide particle coated with the amino groups as claimed in claim 1, wherein the electrode is a positive electrode.

6. The oxide particle coated with the amino groups as claimed in claim 1, wherein a size of the composite LLZO particle is 50 nm to 200 nm.

7. The oxide particle coated with the amino groups as claimed in claim 1, wherein a thickness of the hydroxide ion layer is 0.5 nm˜2 nm.

8. The oxide particle coated with the amino groups as claimed in claim 1, wherein a thickness of the dopamine layer is 1 nm˜10 nm.

9. The oxide particle coated with the amino groups as claimed in claim 1, wherein a plurality of carbon nanotubes and a plurality of nanoscale amorphous carbons are coated on an outer side of the composite LLZO particle.

10. The oxide particle coated with the amino groups as claimed in claim 9, wherein a size of each of the carbon nanotubes is 200 nm˜500 nm; and a size of each of the nanoscale amorphous carbons is 10 nm˜40 nm.

11. The oxide particle coated with the amino groups as claimed in claim 9, wherein a ratio of a total weight of the carbon nanotubes and the nanoscale amorphous carbons and a weight of the first LLZO particle is 0.2˜2:99.8˜98.

12. The oxide particle coated with the amino groups as claimed in claim 2, wherein a plurality of carbon nanotubes and a plurality of nanoscale amorphous carbons are coated on an outer side of the composite LLZO particle.

13. The oxide particle coated with the amino groups as claimed in claim 12, wherein a size of each of the carbon nanotubes is 200 nm˜500 nm; and a size of each of the nanoscale amorphous carbons is 10 nm˜40 nm.

14. The oxide particle coated with the amino groups as claimed in claim 12, wherein a ratio of a total weight of the carbon nanotubes and the nanoscale amorphous carbons and a weight of the first LLZO particle is 0.2˜2:99.8˜98.

15. The oxide particle coated with the amino groups as claimed in claim 3, wherein a plurality of carbon nanotubes and a plurality of nanoscale amorphous carbons are coated on an outer side of the composite LLZO particle.

16. The oxide particle coated with the amino groups as claimed in claim 15, wherein a size of each of the carbon nanotubes is 200 nm˜500 nm; and a size of each of the nanoscale amorphous carbons is 10 nm˜40 nm.

17. The oxide particle coated with the amino groups as claimed in claim 15, wherein a ratio of a total weight of the carbon nanotubes and the nanoscale amorphous carbons and a weight of the first LLZO particle is 0.2˜2:99.8˜98.
